(19) United States
(12) Patent Application Publication
(10) Pub. No.: US 2003/0012541 A1
(43) Pub. Date: Jan. 16, 2003

(54) Protective tube fixing structure for optical fiber sheet and method for fixing protective tube to optical fiber

(76) Inventors: Tsuyoshi Shimomichi, Sakura-shi (JP); Keiji Ohashi, Sakura-shi (JP)

Correspondence Address: Robert M. Barrett, Esq., Bell, Boyd & Lloyd LLC, P.O. Box 1135, Chicago, IL, 60690-1135, US

(21) Appl. No.: 10/115,789

(22) Filed: Apr. 2, 2002

(30) Foreign Application Priority Data
Jul. 16, 2001 (JP) 2001-215038

(51) Int. Cl. G02B 6/36; G02B 6/00

(52) U.S. Cl. 385/134; 385/139; 385/147

(57) ABSTRACT

The present invention provides a simple method for fixing a protective tube covering an optical fiber extending from an end of an optical fiber sheet to the optical fiber sheet. The method comprises the steps of: abutting the protective tube against the end of the optical fiber sheet; setting metallic molds so as to surround the abutted portion of the protective tube and the end of the optical fiber sheet; and injecting a hot-melt resin into the metallic molds so as to cover the abutted portion with the hot-melt resin. According to this simple method, the protective tube can be fixed to the optical fiber sheet with a sufficient strength.

### BACKGROUND OF THE INVENTION

1. Field of the Invention

This invention relates to a protective tube fixing structure for an optical fiber sheet, in which the protective tube covers an optical fiber extending from an edge of the optical fiber sheet, and is fixed to the optical fiber sheet. This invention also relates to a method for fixing a protective tube to an optical fiber sheet.

2. Background Art

As shown in FIGS. 6A and 6B, an optical fiber sheet 1 having flexibility comprises an optical fiber 2 and two sheets 3a and 3b, in which the optical fiber 2 is disposed on the sheet 3a, and the other sheet 3b is adhered to the sheet 3a so that the optical fiber 2 is fixed between the two sheets 3a and 3b. When the optical fiber 2 of this type of optical fiber sheet 1 is connected via, for example, an optical connector to a part at a distance of several tens of centimeters from a sheet edge 3c of the optical fiber sheet 1, the extending portion the optical fiber 2 is covered with a protective tube so as to form a cord, in order to protect the portion of the optical fiber 2 extending from the sheet edge 3c.

FIG. 6 is a simplified figure, and typically, a plurality of curved optical fibers are disposed in an optical fiber sheet.

When the portion of the optical fiber 2 extending from the sheet edge is covered with a protective tube as described above, the protective tube must be fixed to the sheet 3; otherwise, a sharp bending may occur at a boundary area, i.e., at the sheet edge, due to difference in stiffness between the protective tube and the sheet 3, and the optical fiber 2 may be damaged, or may even be disconnected.

A conventional measure to prevent the optical fiber 2 from being damaged at the sheet edge is to separate the sheets at their edge, insert the protective tube between the two sheets, and adhere the sheets again so as to be fixed. Another measure is to sandwich the sheet edge with two halves 5a formed by an end portion of the protective tube 5, and adhere adhesive sheets 6 onto the halves 5a for reinforcement so as to fix the protective tube 5 to the sheet 3, as shown in FIG. 7.

In the fixing measure for the protective tube in which the protective tube is inserted between the two sheets and the sheets are adhered to each other again, it is difficult to fix the protective tube to the sheet 3 with a sufficient strength.

In the latter fixing measure in which the sheet edge is sandwiched between the two halves 5a of the protective tube 5 and the adhesive sheets 6 are adhered, a complicated and inefficient operation is required.

### SUMMARY OF THE INVENTION

An object of the present invention is to solve the above problems by providing a fixing structure and a method for fixing a protective tube to an optical fiber sheet in which the protective tube is fixed to the sheet with a sufficient strength and the fixing operation can be performed efficiently.

In order to achieve the object, according to a first aspect of the present invention, there is provided a structure for fixing a protective tube covering an optical fiber extending from an end of an optical fiber sheet to the optical fiber sheet wherein the protective tube is abutted against the end of the optical fiber sheet, and wherein the abutted portion of the protective tube and the end of the optical fiber sheet is covered with a hot-melt resin.

According to a second aspect of the present invention, there is provided a method for fixing a protective tube covering an optical fiber extending from an end of an optical fiber sheet to the optical fiber sheet comprising the steps of: abutting the protective tube against the end of the optical fiber sheet; setting molds so as to surround the abutted portion of the protective tube and the end of the optical fiber sheet; and injecting a hot-melt resin into the molds so as to cover the abutted portion with the hot-melt resin.

### BRIEF DESCRIPTION OF THE DRAWINGS

FIG. 1 is a plan view showing a fixing portion fixing the protective tube to the optical fiber sheet in an embodiment according to the present invention.

FIG. 2 is a cross-section taken along line A-A in FIG. 1.

FIG. 3 is a cross-section taken along line B-B in FIG. 2.

FIG. 4 is a cross-section taken along line C-C in FIG. 2.

FIG. 5 is a plan view showing a fixing portion fixing the protective tube to the optical fiber sheet in another embodiment of the present invention.

FIG. 6A is a plan view schematically showing a typical optical fiber sheet, and FIG. 6B is a cross-section taken along line D-D in FIG. 6A.

FIG. 7 is cross-section showing a fixing portion fixing the protective tube to the optical fiber sheet as in a conventional construction.

### DETAILED DESCRIPTION OF THE PREFERRED EMBODIMENTS

The preferred embodiments of the present invention will be explained with reference to the accompanying drawings.

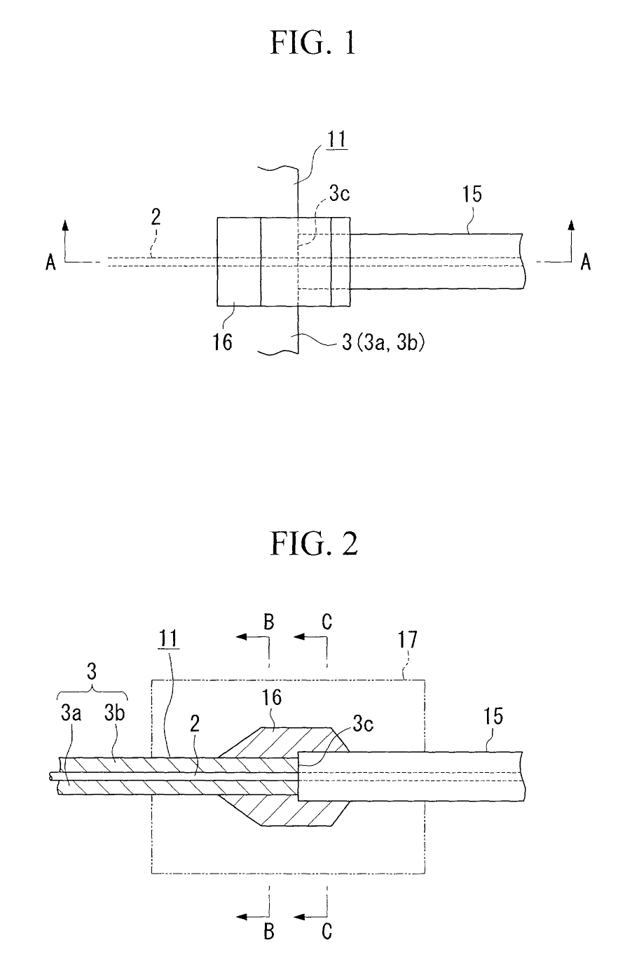

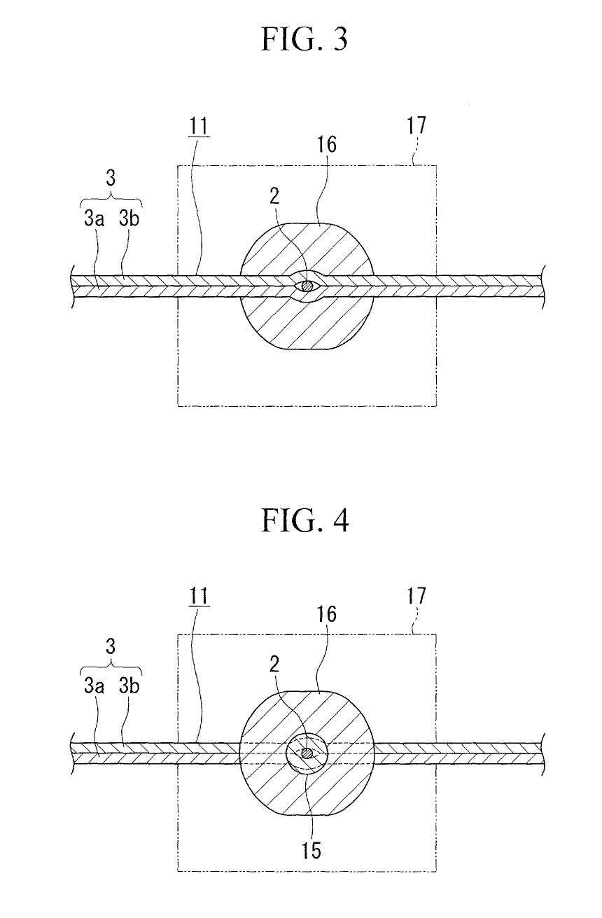

FIG. 1 is a plan view showing a fixing portion fixing the protective tube to the optical fiber sheet in an embodiment according to the present invention, FIG. 2 is a cross-section taken along line A-A in FIG. 1, FIG. 3 is a cross-section taken along line B-B in FIG. 2, and FIG. 4 is a cross-section taken along line C-C in FIG. 2. In these drawings, reference symbol 11 indicates an optical fiber sheet. The optical fiber sheet 11 having flexibility is formed such that an optical fiber 2 is disposed on a sheet 3a, and the other sheet 3b is adhered to the sheet 3a so that the optical fiber 2 is fixed between the two sheets 3a and 3b. In order to protect a portion of the optical fiber 2 extending from the sheet edge 3c of the optical fiber sheet 1, the portion is covered with a protective tube 15 so as to form a cord.

The sheet 3 is preferably made of, for example, polyimide, polyethylene terephthalate (PET), polyethylene, or polypropylene, etc., and one side surface (adhering surface) thereof is coated with pressure-sensitive adhesive. The protective tube 15 is preferably made of nylon or Hytrel® (polyester elastomer). The optical fiber disposed within the sheet 3 is typically a so-called UV line which is made by coating a UV-curable resin on a bare fiber, and whose diameter is 250 μm.

According to the present invention, the protective tube 15 is abutted against the sheet edge 3c, and the abutted portion, i.e., the portion adjacent to the sheet edge 3c, is coated with a hot-melt resin 16; thus, the protective tube 15 is fixed to the sheet 3.

A method for forming such a structure preferably comprises the steps of abutting the protective tube 15 against the sheet edge 3c; setting metallic molds 17 so as to surround the abutted portion; and injecting a hot-melt resin into the metallic molds 17 so as to cover the abutted portion of the protective tube 15 and the sheet edge 3c with the hot-melt resin 16.

When the protective tube 15 is fixed to the sheet 3 in accordance with the above method, the protective tube 15 is fixed to the sheet 3 with a sufficient strength since the abutted portion of the protective tube 15 and the sheet edge 3c is fixedly supported by the hot-melt resin 16.

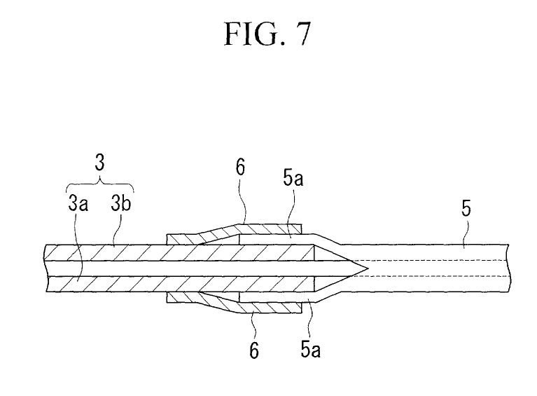

The fixing operation is simple because it does not require a complicated operation as in the in prior art such that an end of the protective tube is separated in half and adhesive sheets are adhered, as show in FIG. 7.

The hot-melt resin herein means a resin which is typically used as a hot-melt adhesive, and which, during use, is heated so as to exhibit flowability and solidifies when cooled. The hot-melt resin is preferably a resin such as polypropylene (PP), or ethylene-vinyl acetate copolymer (EVA) which exhibits flexibility, and whose melting point is lower than 150° C. so as not to cause heat damage in the sheet 3, the protective tube 15, and the optical fiber 2. Although PP and EVA are preferable, a resin other than PP or EVA may be used, and the melting point is not limited to be lower than 150° C.

The metallic mold used for forming the hot-melt resin need not exhibit a high temperature resistance or high pressure resistance as is required for a typical injection mold. The mold may be made of, for example, aluminum or plastic since neither high accuracy nor high wear resistance is required. The mold is merely required to provide a cavity into which the hot-melt resin is supplied. The details of the mold are not referred to herein; however, the mold preferably consists of two halves which mate with each other while sandwiching the sheet 3.

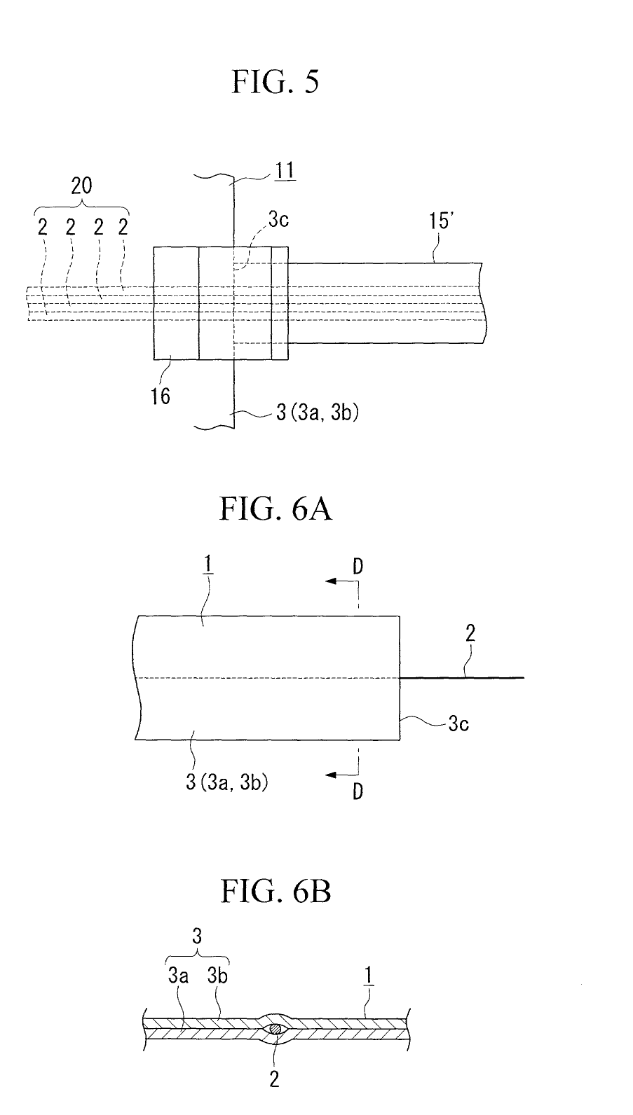

Although the foregoing embodiment relates to a single type optical fiber 2 extending from the sheet edge, the present invention is also applicable to a multiple type optical fiber 20 extending from the sheet edge 3, as shown in FIG. 5. In this case, the hot-melt resin 16′ is similarly applied while the protective tube 15′ covering the multiple type optical fiber 20 is abutted against the sheet edge 3c, so that the protective tube 15′ is fixed to the sheet 3.

According to the present invention, the protective tube is fixed to the sheet with a sufficient strength since the abutted portion of the protective tube and the sheet edge is fixedly supported by the hot-melt resin.

The workability for fixing is improved because the fixing operation is simple such that the metallic molds are set while the protective tube is abutted against the sheet edge, and then the hot-melt resin is injected into the molds, and because it does not require a complicated operation as in the conventional construction such that an end of the protective tube is separated in half and adhesive sheets are adhered.

What is claimed is:

1. A structure for fixing a protective tube covering an optical fiber extending from an end of an optical fiber sheet to said optical fiber sheet wherein said protective tube is abutted against said end of said optical fiber sheet, and wherein the abutted portion of said protective tube and said end of said optical fiber sheet is covered with a hot-melt resin.

2. A structure according to claim 1, wherein said hot-melt resin is selected from polypropylene (PP), or ethylene-vinyl acetate copolymer (EVA).

3. A method for fixing a protective tube covering an optical fiber extending from an end of an optical fiber sheet to said optical fiber sheet comprising the steps of
abutting said protective tube against said end of said optical fiber sheet;
setting molds so as to surround the abutted portion of said protective tube and said end of said optical fiber sheet; and
injecting a hot-melt resin into said molds so as to cover said abutted portion with said hot-melt resin.

4. A method according to claim 3, wherein said hot-melt resin is selected from polypropylene (PP), or ethylene-vinyl acetate copolymer (EVA).
